(19) United States
(12) Patent Application Publication
(10) Pub. No.: US 2018/0032161 A1
(43) Pub. Date: Feb. 1, 2018

(54) PEN, DISTANCE MEASUREMENT METHOD AND DISTANCE MEASUREMENT DEVICE

(71) Applicants: BOE TECHNOLOGY GROUP CO., LTD., Beijing (CN); BEIJING BOE MULTIMEDIA TECHNOLOGY CO., LTD., Beijing (CN)

(72) Inventors: Xiaodong SHI, Beijing (CN); Huiran TIAN, Beijing (CN); Hongna YE, Beijing (CN); Quanzhong WANG, Beijing (CN); Bin ZOU, Beijing (CN)

(73) Assignees: BOE TECHNOLOGY GROUP CO., LTD., Beijing (CN); BEIJING BOE MULTIMEDIA TECHNOLOGY CO., LTD., Beijing (CN)

(21) Appl. No.: 15/647,613

(22) Filed: Jul. 12, 2017

(30) Foreign Application Priority Data
Jul. 26, 2016 (CN) 201610599299.6

(51) Int. Cl. G06F 3/0354; G01S 5/22; G06F 3/038; G06F 3/043

(52) U.S. Cl. CPC G06F 3/03545; G06F 3/0433; G01S 5/22; G06F 3/0383; G06F 2203/0384

(57) ABSTRACT

The present disclosure provides a pen, a distance measurement method and a distance measurement device. The pen includes: a housing; a processor configured to receive a triggering instruction, to trigger a distance-measurement circuit to transmit a distance-measurement signal to a to-be-measured object; and the distance-measurement circuit configured to receive the distance-measurement signal reflected by the to-be-measured object. The processor is further configured to: start a timer after the distance-measurement circuit has transmitted the distance-measurement signal to the to-be-measured object, and stop the timer after the distance-measurement circuit has received the distance-measurement signal reflected by the to-be-measured object, to acquire a value of the timer; and calculate a measurement distance between the pen and the to-be-measured object in accordance with the value of the timer.

### CROSS-REFERENCE TO RELATED APPLICATION

The present application claims priority to Chinese Patent Application No. 201610599299.6 filed on Jul. 26, 2016, which is incorporated herein by reference in its entirety.

### TECHNICAL FIELD

The present disclosure relates to the field of electronic device, in particular to a pen, a distance measurement method and a distance measurement device.

### BACKGROUND

In daily life and industrial production, a distance needs to be measured and recorded in many scenarios. For example, in the case of measuring an area of a building, usually a tape measure or a steel tape may be used. At this time, although available, an error may occur in the case of long-distance measurement, storey height measurement or for a least accessible area. In addition, after reading a distance, it is necessary to provide a specific tool to record the distance, resulting in high labor intensity and a complicated job. In rapid technology development of today, obviously, such a traditional measurement method cannot meet the requirements on efficiency for information society.

### SUMMARY

An object of the present disclosure is to provide a pen capable of measuring a distance, a distance measurement method, and a distance measurement device, so as to measure and record a distance at a time, thereby to reduce the labor intensity and improve the work efficiency.

In one aspect, the present disclosure provides in some embodiments a pen, including a housing, and a distance-measurement circuit and a processor arranged on the housing. The processor is configured to receive a triggering instruction so as to trigger the distance-measurement circuit to transmit a distance-measurement signal to a to-be-measured object. The distance-measurement circuit is connected to the processor, and configured to transmit the distance-measurement signal to the to-be-measured object and receive the distance-measurement signal reflected by the to-be-measured object. The processor is further configured to: start a timer after the distance-measurement signal has been transmitted by the distance-measurement circuit to the to-be-measured object, and stop the timer after the distance-measurement circuit has received the distance-measurement signal reflected by the to-be-measured object, so as to acquire a value of the timer; and calculate a measurement distance between the pen and the to-be-measured object in accordance with the value of the timer.

In a possible embodiment of the present disclosure, the pen further includes a display module connected to the processor and configured to display the measurement distance.

In a possible embodiment of the present disclosure, the pen further includes a writing mechanism configured to enable a user to record the measurement distance onto a medium.

In a possible embodiment of the present disclosure, the distance-measurement circuit includes: a distance-measurement signal transmission circuit configured to transmit the distance-measurement signal to the to-be-measured object, and a distance-measurement signal reception circuit configured to receive the distance-measurement signal reflected by the to-be-measured object.

In a possible embodiment of the present disclosure, the distance-measurement signal transmission circuit includes a waveform generator configured to generate a pulse signal, and a distance-measurement signal transmission probe configured to receive the pulse signal and transmit the distance-measurement signal to the to-be-measured object in accordance with the pulse signal.

In a possible embodiment of the present disclosure, the distance-measurement signal reception circuit includes: a distance-measurement signal reception probe configured to receive the distance-measurement signal reflected by the to-be-measured object, and an amplifier configured to amplify the distance-measurement signal reflected by the to-be-measured object.

In a possible embodiment of the present disclosure, the pen further includes a temperature detection circuit connected to the processor and configured to detect an ambient temperature. The processor is further configured to calculate a speed of the distance-measurement signal in accordance with the ambient temperature, and calculate the measurement distance between the pen and the to-be-measured object in accordance with the value of the timer.

In a possible embodiment of the present disclosure, the pen further includes a communication circuit connected to the processor and configured to communicate with a terminal device so as to transmit the measurement distance to the terminal device.

In a possible embodiment of the present disclosure, the communication circuit communicates with the terminal device via Bluetooth or an infrared communication mode.

In a possible embodiment of the present disclosure, the pen further includes a prompt circuit connected to the processor and configured to receive a prompt signal from the processor after the processor has calculated the measurement distance, and send a prompt to the user in accordance with the prompt signal. The prompt includes at least one of sound, light and vibration.

In a possible embodiment of the present disclosure, the pen further includes a power source connected to the processor and configured to supply power to the pen.

In a possible embodiment of the present disclosure, the power source is a flexible lithium polymer battery provided on an inner wall of the housing.

In a possible embodiment of the present disclosure, the distance-measurement circuit is arranged at one end of the pen, and the other end of the pen is in contact with an original object. The processor is further configured to acquire a sum of the measurement distance and a predetermined length as the distance between the original object and the to-be-measured object. The predetermined length is a length of the pen.

In a possible embodiment of the present disclosure, the distance-measurement signal includes at least one of an ultrasonic wave, a laser beam and an infrared ray.

In another aspect, the present disclosure provides in some embodiments a distance measurement method, including steps of: receiving a triggering instruction from a user and transmitting a distance-measurement signal to a to-be-measured object; receiving the distance-measurement signal reflected by the to-be-measured object; and starting a timer after the distance-measurement signal has been transmitted to the to-be-measured object and stopping the timer after the distance-measurement signal reflected by the to-be-measurement object has been received so as to acquire a value of the timer, and calculating a measurement distance between a pen and the to-be-measured object in accordance with the value of the timer.

In a possible embodiment of the present disclosure, the distance measurement method further includes: detecting an ambient temperature; and calculating a speed of the distance-measurement signal in accordance with the ambient temperature and calculating the distance between the pen and the to-be-measured object in accordance with the value of the timer.

In a possible embodiment of the present disclosure, the distance measurement method further includes: generating a prompt signal after the distance between the pen and the to-be-measured object has been calculated; and sending a prompt to the user in accordance with the prompt signal. The prompt includes at least one of sound, light and vibration.

In yet another aspect, the present disclosure provides in some embodiments a distance measurement device including the above-mentioned pen and a terminal device configured to receive from the pen the distance between the pen and a to-be-measured object.

According to the embodiments of the present disclosure, the pen includes the housing, and the distance-measurement circuit and the processor arranged on the hosing. The processor is configured to receive the triggering instruction so as to trigger the distance-measurement circuit to transmit the distance-measurement signal to the to-be-measured object. The distance-measurement circuit is connected to the processor, and configured to transmit the distance-measurement signal to the to-be-measured object and receive the distance-measurement signal reflected by the to-be-measured object. The processor is further configured to start the timer after the distance-measurement circuit has transmitted the distance-measurement signal to the to-be-measured object and stop the timer after the distance-measurement circuit has received the distance-measurement signal reflected by the to-be-measured object, so as to acquire the value of the timer, and then calculate the measurement distance between the pen and the to-be-measured object in accordance with the value of the timer. In addition, the user may record the measurement distance onto a medium directly by using the pen. As a result, it is able to measure and record the distance at a time, so as to reduce the labor intensity and improve the work efficiency.

### BRIEF DESCRIPTION OF THE DRAWINGS

In order to illustrate the technical solutions of the present disclosure or the related art in a clearer manner, the drawings desired for the present disclosure or the related art will be described hereinafter briefly. Obviously, the following drawings merely relate to some embodiments of the present disclosure, and based on these drawings, a person skilled in the art may obtain the other drawings without any creative effort.

FIG. 1 is a schematic view showing an appearance structure of a pen according to one embodiment of the present disclosure;

FIG. 2 is another schematic view showing an inner structure of the pen according to one embodiment of the present disclosure;

FIG. 3 is yet another schematic view showing a structure of the pen according to one embodiment of the present disclosure;

FIG. 4 is still yet another schematic view showing a structure of the pen according to one embodiment of the present disclosure;

FIG. 5 is still yet another schematic view showing a structure of the pen according to one embodiment of the present disclosure;

FIG. 6 is a schematic view showing a distance measurement mode according to one embodiment of the present disclosure;

FIG. 7 is a flow chart of a distance measurement method according to one embodiment of the present disclosure;

FIG. 8 is another flow chart of the distance measurement method according to one embodiment of the present disclosure; and

FIG. 9 is yet another flow chart of the distance measurement method according to one embodiment of the present disclosure.

### DETAILED DESCRIPTION OF THE EMBODIMENTS

In order to make the objects, the technical solutions and the advantages of the present disclosure more apparent, the present disclosure will be described hereinafter in a clear and complete manner in conjunction with the drawings and embodiments. Obviously, the following embodiments merely relate to a part of, rather than all of, the embodiments of the present disclosure, and based on these embodiments, a person skilled in the art may, without any creative effort, obtain the other embodiments, which also fall within the scope of the present disclosure.

Unless otherwise defined, any technical or scientific term used herein shall have the common meaning understood by a person of ordinary skills. Such words as “first” and “second” used in the specification and claims are merely used to differentiate different components rather than to represent any order, number or importance. Similarly, such words as “one” or “one of” are merely used to represent the existence of at least one member, rather than to limit the number thereof. Such words as “connect” or “connected to” may include electrical connection, direct or indirect, rather than to be limited to physical or mechanical connection. Such words as “on”, “under”, “left” and “right” are merely used to represent relative position relationship, and when an absolute position of the object is changed, the relative position relationship will be changed too.

As shown in FIGS. 1, 2 and 3, the present disclosure provides in some embodiments a pen, including a housing 1, and a distance-measurement circuit 2 and a processor 3 arranged on the housing 1. The processor 3 is configured to receive a triggering instruction so as to trigger the distance-measurement circuit 2 to transmit a distance-measurement signal to a to-be-measured object. The distance-measurement circuit 2 is connected to the processor 3 and configured to transmit the distance-measurement signal to the to-be-measured object and receive the distance-measurement signal reflected by the to-be-measured object. The processor 3 is further configured to: start a timer after the distance-measurement signal has been transmitted by the distance-measurement circuit 2 to the to-be-measured object, and stop the timer after the distance-measurement circuit 2 has received the distance-measurement signal reflected by the to-be-measured object, so as to acquire a value of the timer; and calculate a measurement distance between the pen and the to-be-measured object in accordance with the value of the timer.

For example, the measurement distance between the pen and the to-be-measured object may be calculated in accordance with the value of the timer and a transmission speed of the distance-measurement signal. The processor may be a Micro Control Unit (MCU), a Field Programmable Gate Array (FPGA), a single chip microcomputer, an Acorn Reduced Instruction-Set Computer (RISC) Machine (ARM) or any other circuit having a logic calculation function. The processor may receive the triggering instruction transmitted by the user through a button, a remote signal or any other forms. The distance-measurement signal may include at least one of an ultrasonic wave, a laser beam or an infrared ray. The housing 1 mainly has a support and protection function, so as to protect mechanical members and the circuits within the housing, e.g., a refill (sign 11 in FIG. 2) for writing, a cap (sign 12 in FIGS. 1 and 2), and the circuits for achieving the functions of the processor and the distance-measurement circuit. The housing 1 may be made of any common materials, such as plastics or stainless steel, and the housing 1 may be of a cylindrical or cuboidal shape, or any other shapes.

In this way, the user may directly use the pen to record the measurement distance onto a medium, so as to measure and record the measurement distance at a time, thereby to reduce the labor intensity and improve the work efficiency.

It should be appreciated that, a writing mechanism 4 may be further arranged on the housing 1 and configured to record the measurement distance onto a medium by the user. Here, the writing mechanism 4 may be a refill, or a magnetic medium head. The medium may be a physical medium such as paper, or an electronic medium such as a touch terminal, which will not be particularly defined herein. For example, the writing mechanism 4 may be arranged at one end of the pen, and the distance-measurement circuit 2 may be arranged at the other end of the pen. In the case of measuring the distance, the distance-measurement circuit may be turned toward the to-be-measured object, and after the measurement, the writing mechanism may be turned toward the medium, so as to record the distance. In addition, the pen may further include a display module 5 connected to the processor 3 and configured to display the measurement distance, so as to enable the user to record the measurement distance conveniently after reading the measurement distance on the display module 5. The display module 5 may be a Light-Emitting Diode (LED) display panel or a Liquid Crystal Display (LCD) panel.

In addition, for information communication, a communication circuit 6 may be further arranged on the housing 1. The communication circuit 6 is connected to the processor 3 and communicates with the terminal device (i.e. user equipment (UE)) via Bluetooth or an infrared communication mode. In the case of Bluetooth, the communication circuit 6 may include a module capable of supporting Bluetooth Low Energy (BLE) and a Bluetooth 4.0 or higher protocol. In addition, the communication circuit 6 may be built in the processor.

In order to prompt the user that the distance measurement has been completed, a prompt circuit 7 may be further arranged on the housing 1. The prompt circuit 7 is connected to the processor 3, and configured to receive a prompt signal from the processor 3 after the processor 3 has calculated and obtained the measurement distance, and send a prompt to the user in accordance with the prompt signal. The prompt may include at least one of sound, light and vibration. In addition, a power source 8 may be further arranged on the housing. The power source 8 is connected to the processor 3 and configured to supply power to the pen. Such a common power source as button battery, common lithium battery is difficult to be miniaturized to be placed within the housing, so a specific flexible lithium polymer battery may be wound to or attached to an inner wall of the housing, so as to ensure a maximum volume of the battery, thereby to supply power to the pen at a maximum possible electricity quantity.

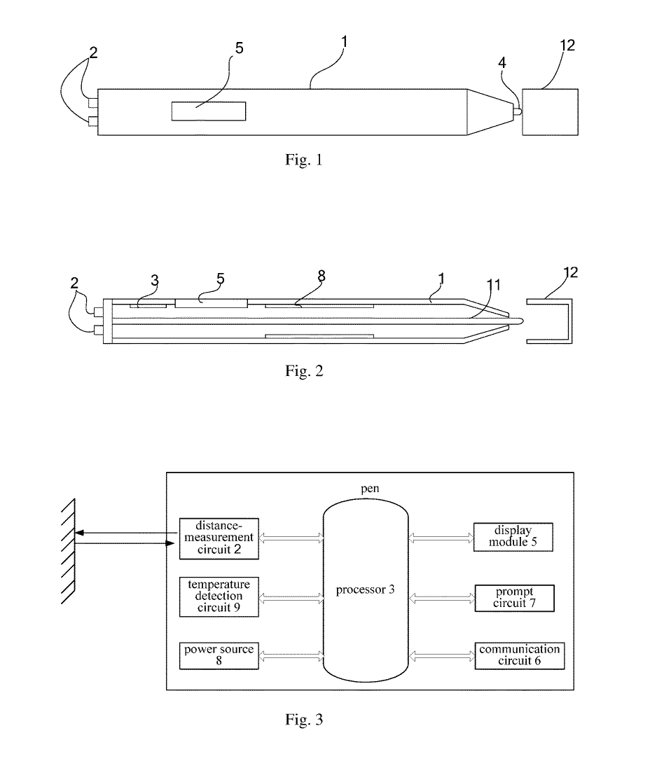

Further, the transmission speed of the distance-measurement signal in air is seriously affected by temperature. In order to improve the measurement accuracy, as shown in FIG. 3, the pen may further includes a temperature detection circuit 9 connected to the processor 3 and configured to detect an ambient temperature. The processor 3 is further configured to calculate the speed of the distance-measurement signal in accordance with the ambient temperature, and calculate the measurement distance between the pen and the to-be-measured object in accordance with the value of the timer.

The temperature detection circuit 9 may mainly include a temperature sensor configured to detect and convert a temperature signal into an electric signal representing the temperature, and transmit the electric signal to the processor 3. Then, the processor 3 may calculate the current ambient temperature and calculate the speed of the distance-measurement signal in accordance with the ambient temperature. The temperature detection circuit 9 may be a temperature sensor merely capable of outputting an analog signal representing the ambient temperature, or a temperature sensor having an analog-to-digital function and thus capable of directly outputting the ambient temperature. The temperature sensor may be a Negative Temperature Coefficient (NTC) thermosensitive resistor, the accuracy of which may be up to 0.1° C.

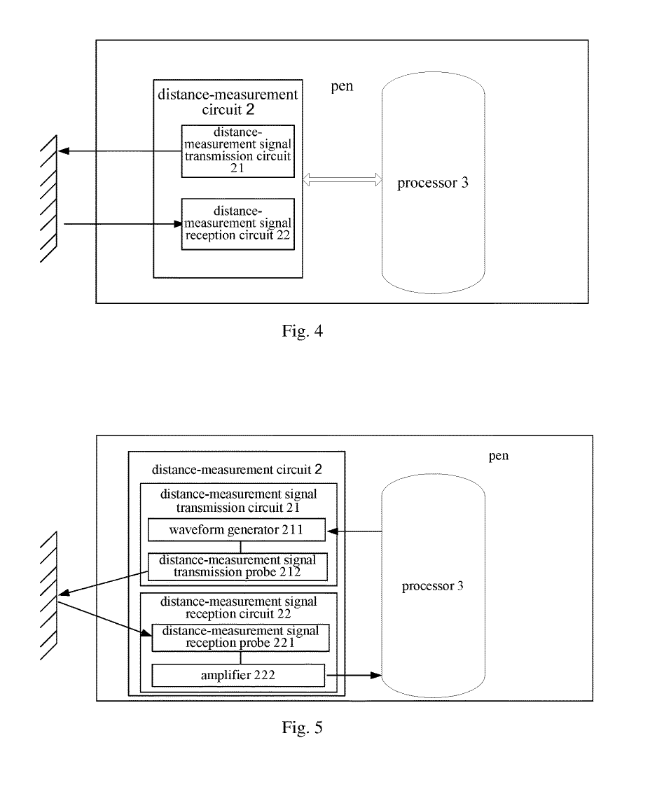

As shown in FIGS. 4 and 5, the distance-measurement circuit 2 may include a distance-measurement signal transmission circuit 21 configured to transmit the distance-measurement signal to the to-be-measured object, and a distance-measurement signal reception circuit 22 configured to receive the distance-measurement signal reflected by the to-be-measured object.

To be specific, the distance-measurement signal transmission circuit 21 includes a waveform generator 211 configured to generate a pulse signal, and a distance-measurement signal transmission probe 212 configured to receive the pulse signal and transmit the distance-measurement signal to the to-be-measured object in accordance with the pulse signal.

For example, the waveform generator 211 may be a timer for generating a square wave pulse signal at a frequency of 40 KHz and applying the square wave pulse signal to a pin of the distance-measurement signal transmission probe for measurement. For example, in the case that the distance-measurement signal is an ultrasonic signal, the distance-measurement signal transmission probe may be an ultrasonic wave generator, i.e., a piezoelectric wafer inside the distance-measurement signal transmission probe may generate resonance so as to generate an ultrasonic wave as the distance-measurement signal. The ultrasonic wave generator may generate the ultrasonic wave in an electrical or mechanical way. In the electrical way, the ultrasonic wave generator may be of a piezoelectric, magnetostrictive or electrodynamic type, and in the mechanical way, it may be of a Garr flute, liquid whistle or airflow siren type. These ultrasonic wave generators may generate the ultrasonic waves at different frequencies, power and acoustic characteristics, so they may be applied to different scenarios. Here, the types of the ultrasonic wave generators will not be particularly defined.

The distance-measurement signal reception circuit 22 includes a distance-measurement signal reception probe 221 configured to receive the distance-measurement signal reflected by the to-be-measured object, and an amplifier 222 configured to amplify the distance-measurement signal reflected by the to-be-measured object.

Signal power of the distance-measurement signal reflected by the to-be-measured object and received by the distance-measurement signal reception probe 221 may be attenuated due to a long reflection path, and in the case that a large interference noise is introduced, a subsequent parsing operation by the circuit may be adversely affected. Hence, the signal may be amplified by the amplifier 222 and then transmitted to the processor 3.

For example, in the case that the distance-measurement signal is an ultrasonic wave, a commonly-used piezoelectric-type ultrasonic wave generator may be used to generate the ultrasonic wave. During the distance measurement, usually a time of flight (TOF) method may be used for the ultrasonic distance measurement, i.e., the measurement distance s may be calculated using the following equation: s=vt, where v represents a transmission speed of the ultrasonic wave in the medium, which may be calculated by v=331.4\sqrt{1+T/273} m/s and t represents a round-trip time period of the ultrasonic wave.

The operation principle will be described as follows. The ultrasonic wave from the distance-measurement circuit 2 may be transmitted in the air at a speed v, and then reflected by the to-be-measured object and received by the distance-measurement circuit 2. The round-trip time period may be t, and the measurement distance s may be calculated using the above-mentioned equation. T represents the ambient temperature. In a scenario where a high measurement accuracy is demanded, the temperature must be taken into consideration. However, in a common circumstance, the TOF method may not be used, and instead adjustment and compensation may be performed by software. The ultrasonic wave is also a sound wave, and the sound speed c is related to the temperature. The sound speed at several temperatures is listed in Table 1. In use, in the case that the temperature does not change remarkably, the sound speed may be deemed as substantially unchanged. In the case that the high measurement accuracy is demanded, the sound speed may be modified through the temperature compensation. Upon the determination of the sound speed, it is able to calculate the measurement distance in accordance with the round-trip time period of the ultrasonic wave.

TABLE 1
relationship between temperature and sound speed

| | Temperature (° C.) | | | | | | | |
|---|---|---|---|---|---|---|---|---|
| | −30 | −20 | −10 | 0 | 10 | 20 | 30 | 100 |
| Sound speed | 313 | 319 | 325 | 333 | 338 | 344 | 349 | 386 |
| (m/s) | | | | | | | | |

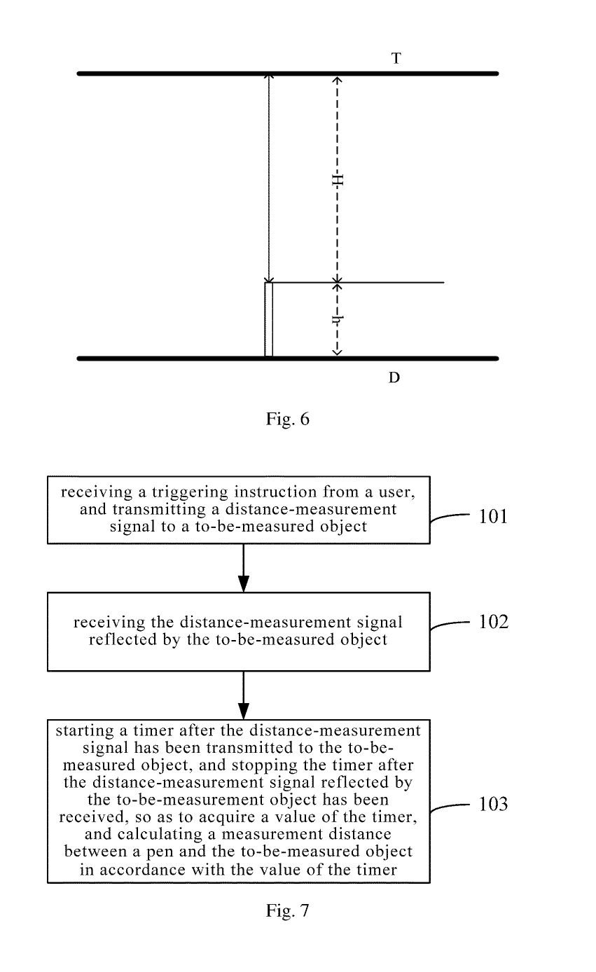

Further, the distance-measurement circuit 2 may be arranged at one end of the pen, and the other end of the pen may be in contact with an original object. The processor 3 is further configured to acquire a sum of the measurement distance between the pen and the to-be-measured object and a predetermined length as the distance between the original object and the to-be-measured object. The predetermined length is a length of the pen. For example, as shown in FIG. 6, in the case of measuring the distance between two obstacles, the measurement distance between one end of the pen where the distance-measurement circuit 2 is located and the to-be-measured object, i.e., the distance between the end of the pend and one of the obstacle, may be measured. At this time, a length of the housing of the pen is already known. In the case that the other end of the pen is in contact with the original object, it is able to acquire the distance between the original object, i.e., the other one of the obstacles, and the end of the pen where the distance-measurement circuit 2 is located (i.e., the length of the pen). The distance between the two obstacles is just the sum of the measurement distance between the pen and the to-be-measured object and the length of the pen. In this regard, an application range of the pen may be enlarged. To be specific, within a measurement range of the ultrasonic wave, the distance between any two obstacles (this distance must be greater than the length of the pen), e.g., between a ceiling T and a ground D of a building, may be acquired by placing the pen vertically onto the ground D, and the measurement distance is equal to a sum of the length of the pen (h) and a distance H between an end of the pen (where the distance-measurement circuit 2 is located) and the ceiling. In addition, the processor may be further configured to display the measurement distance on a display module or transmit it to the terminal device.

In addition, the pen may be used to measure a relative distance between the to-be-measured object and the pen. Of course, in order to acquire an actual position of the to-be-measured object, the pen may further be provided with a positioning module, e.g., a Global Positioning System (GPS) or BeiDou Navigation Satellite System (BDNS) system module for positioning the actual position of the pen. Then, a nominal actual position of the to-be-measured object may be acquired in accordance with the measurement distance between the pen and the to-be-measured object.

The present disclosure further provides in some embodiments a distance measurement device including the above-mentioned pen and a terminal device configured to receive from the pen the measurement distance between the pen and the to-be-measured object.

As shown in FIG. 7, the present disclosure further provides in some embodiments a distance measurement method, including: Step 101 of receiving a triggering instruction from a user and transmitting a distance-measurement signal to a to-be-measured object; Step 102 of receiving the distance-measurement signal reflected by the to-be-measured object; and Step 103 of starting a timer after the distance-measurement signal has been transmitted to the to-be-measured object and stopping the timer after the distance-measurement signal reflected by the to-be-measurement object has been received so as to acquire a value of the timer, and calculating a measurement distance between a pen and the to-be-measured object in accordance with the value of the timer.

In addition, the measurement distance between the pen and the to-be-measured object may also be displayed. Further, upon the acquisition of the measurement distance, a prompt signal may be generated, and a prompt may be sent to the user in accordance with the prompt signal so as to prompt the user that the distance measurement has been completed.

In this way, the user may directly use the pen to record the measurement distance onto a medium, so as to measure and record the measurement distance at a time, thereby to reduce the labor intensity and improve the working efficiency.

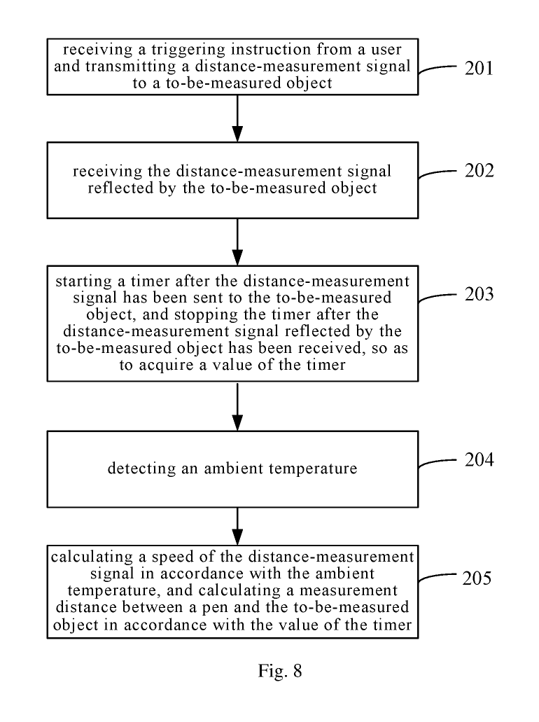

Further, in order to improve the measurement accuracy, as shown in FIG. 8, the distance measurement method may include: Step 201 of receiving the triggering instruction from the user and transmitting the distance-measurement signal to the to-be-measured object; Step 202 of receiving the distance-measurement signal reflected by the to-be-measured object; Step 203 of starting a timer after the distance-measurement signal has been sent to the to-be-measured object, and stopping the timer after the distance-measurement signal reflected by the to-be-measured object has been received, so as to acquire a value of the timer; Step 204 of detecting an ambient temperature; and Step 205 of calculating a speed of the distance-measurement signal in accordance with the ambient temperature, and calculating the measurement distance between the pen and the to-be-measured object in accordance with the value of the timer.

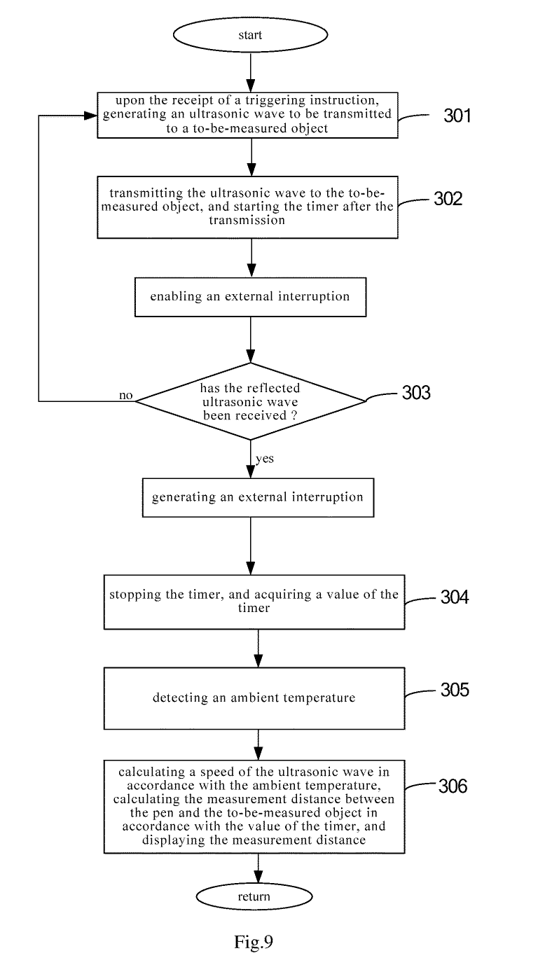

To be specific, by taking the ultrasonic wave as the distance-measurement signal as an example, as shown in FIG. 9, the distance measurement method may include the following steps.

Step 301: upon the receipt of the triggering instruction, generating an ultrasonic wave to be transmitted to the to-be-measured object. For example, the ultrasonic wave may include 8 square waves each having a frequency of 40 KHz.

Step 302: transmitting the ultrasonic wave to the to-be-measured object, and starting the timer after the transmission. For example, a counter may be used, and after the last one of the 8 square waves have been transmitted, the counter may be started. At this time, an external interruption may be enabled by the processor so as to wait for receiving the reflected ultrasonic wave.

Step 303: determining whether or not the reflected ultrasonic wave has been received.

Step 304: in the case that the reflected ultrasonic wave has been received, stopping the timer, and acquiring a value of the timer. To be specific, in Step 304, in the case that the reflected ultrasonic wave has been received, an external interruption may be generated and the counter may be stopped at a time. In the case that the reflected ultrasonic wave has not been received yet, a certain number of pulse waveforms may be regenerated and transmitted to the to-be-measured object. Here, the form and the number of the ultrasonic waves will not be particularly defined.

Step 305: detecting an ambient temperature.

Step 306: calculating a speed of the ultrasonic wave in accordance with the ambient temperature, calculating the measurement distance between the pen and the to-be-measured object in accordance with the value of the timer, and displaying the measurement distance.

Next, the counter may be reset for the next timing, and it returns to an initial state.

The above are merely the preferred embodiments of the present disclosure, but the present disclosure is not limited thereto. Obviously, a person skilled in the art may make further modifications and improvements without departing from the spirit of the present disclosure, and these modifications and improvements shall also fall within the scope of the present disclosure.

What is claimed is:

1. A pen, comprising a housing, and a distance-measurement circuit and a processor arranged within the housing,
wherein the processor is configured to receive a triggering instruction, to trigger the distance-measurement circuit to transmit a distance-measurement signal to a to-be-measured object;
the distance-measurement circuit is connected to the processor, and configured to transmit the distance-measurement signal to the to-be-measured object and receive the distance-measurement signal reflected by the to-be-measured object; and
the processor is further configured to: start a timer after the distance-measurement signal has been transmitted by the distance-measurement circuit to the to-be-measured object, and stop the timer after the distance-measurement circuit has received the distance-measurement signal reflected by the to-be-measured object, to acquire a value of the timer; and calculate a measurement distance between the pen and the to-be-measured object in accordance with the value of the timer.

2. The pen according to claim 1, further comprising:
a display module connected to the processor and configured to display the measurement distance.

3. The pen according to claim 1, further comprising:
a writing mechanism configured to enable a user to record the measurement distance onto a medium.

4. The pen according to claim 1, wherein the distance-measurement circuit comprises:
a distance-measurement signal transmission circuit configured to transmit the distance-measurement signal to the to-be-measured object; and
a distance-measurement signal reception circuit configured to receive the distance-measurement signal reflected by the to-be-measured object.

5. The pen according to claim 4, wherein the distance-measurement signal transmission circuit comprises:
a waveform generator configured to generate a pulse signal; and
a distance-measurement signal transmission probe configured to receive the pulse signal, and transmit the distance-measurement signal to the to-be-measured object in accordance with the pulse signal.

6. The pen according to claim 4, wherein the distance-measurement signal reception circuit comprises:
a distance-measurement signal reception probe configured to receive the distance-measurement signal reflected by the to-be-measured object; and
an amplifier configured to amplify the distance-measurement signal reflected by the to-be-measured object.

7. The pen according to claim 1, further comprising a temperature detection circuit connected to the processor and configured to detect an ambient temperature,
wherein the processor is further configured to calculate a speed of the distance-measurement signal in accordance with the ambient temperature, and calculate the measurement distance between the pen and the to-be-measured object in accordance with the value of the timer.

8. The pen according to claim 1, further comprising:
a communication circuit connected to the processor, and configured to communicate with a terminal device, to transmit the measurement distance to the terminal device.

9. The pen according to claim 8, wherein the communication circuit is configured to communicate with the terminal device via a Bluetooth communication mode or an infrared communication mode.

10. The pen according to claim 1, further comprising:
a prompt circuit connected to the processor, and configured to receive a prompt signal transmitted from the processor after the processor has calculated the measurement distance, and send a prompt to a user in accordance with the prompt signal, wherein the prompt comprises at least one of sound, light and vibration.

11. The pen according to claim 1, further comprising:
a power source connected to the processor and configured to supply power to the pen.

12. The pen according to claim 11, wherein the power source is a flexible lithium polymer battery provided on an inner wall of the housing.

13. The pen according to claim 1, wherein
the distance-measurement circuit is arranged at one end of the pen, and the other end of the pen is in contact with an original object;
the processor is further configured to acquire a sum of the measurement distance and a predetermined length as the distance between the original object and the to-be-measured object; and
the predetermined length is a length of the pen.

14. The pen according to claim 1, wherein the distance-measurement signal comprises at least one of an ultrasonic wave, a laser beam and an infrared ray.

15. A distance measurement method, comprising:
receiving a triggering instruction from a user, and transmitting a distance-measurement signal to a to-be-measured object;
receiving the distance-measurement signal reflected by the to-be-measured object;
starting a timer after the distance-measurement signal has been transmitted to the to-be-measured object, and stopping the timer after the distance-measurement signal reflected by the to-be-measurement object has been received, to acquire a value of the timer; and
calculating a measurement distance between a pen and the to-be-measured object in accordance with the value of the timer.

16. The distance measurement method according to claim 15, further comprising:
detecting an ambient temperature; and
calculating a speed of the distance-measurement signal in accordance with the ambient temperature, and calculating the measurement distance between the pen and the to-be-measured object in accordance with the value of the timer.

17. The distance measurement method according to claim 15, further comprising:
generating a prompt signal after the measurement distance has been calculated; and
sending a prompt to the user in accordance with the prompt signal, wherein the prompt comprises at least one of sound, light and vibration.

18. A distance measurement device, comprising: the pen according to claim 1, and a terminal device configured to receive the measurement distance transmitted from the pen.

19. The distance measurement device according to claim 18, wherein the pen further comprises:
a display module connected to the processor and configured to display the measurement distance.

20. The distance measurement device according to claim 18, wherein the pen further comprises:
a writing mechanism configured to enable a user to record the measurement distance onto a medium.
